(19) United States
(12) Patent Application Publication
(10) Pub. No.: US 2015/0068664 A1
(43) Pub. Date: Mar. 12, 2015

(54) APPARATUS AND METHOD FOR FLUTING CORRUGATED BOARD OR SOLID BOARD

(71) Applicant: Wilhelm Bahmuller Maschinenbau Prazisionswerkzeuge GmbH, Pluderhausen (DE)

(72) Inventor: Thomas Stober, Urbach (DE)

(21) Appl. No.: 14/477,514

(22) Filed: Sep. 4, 2014

(30) Foreign Application Priority Data
Sep. 9, 2013 (DE) 10 2013 217 994.4
Sep. 20, 2013 (DE) 10 2013 218 955.9
Nov. 21, 2013 (DE) 10 2013 223 854.1

(51) Int. Cl. B31F 1/08; B31F 1/36

(52) U.S. Cl. CPC B31F 1/08; B31F 1/36
USPC 156/73.1; 156/459

(57) ABSTRACT

Apparatus for fluting corrugated board or solid board includes a first sonotrode and an anvil or a second sonotrode disposed opposition to the first sonotrode. A local zone of the solid board or layers of the corrugated board is compressed between the first sonotrode and the anvil or second sonotrode, and then subjected to ultrasound to form a flute line or crease in the corrugated board or solid board.

### CROSS-REFERENCES TO RELATED APPLICATIONS

This application claims the priority of German Patent Applications, Serial Nos. 10 2013 217 994.4, filed Sep. 9, 2013, 10 2013 218 955.9, filed Sep. 20, 2013, and 10 2013 223 854.1, filed Nov. 21, 2013, pursuant to 35 U.S.C. 119(a)-(d), the disclosures of which are incorporated herein by reference in its entirety as if fully set forth herein.

### BACKGROUND OF THE INVENTION

The present invention relates to an apparatus and method for fluting corrugated board or solid board.

The following discussion of related art is provided to assist the reader in understanding the advantages of the invention, and is not to be construed as an admission that this related art is prior art to this invention.

To ensure clarity, it is to be understood by persons skilled in the art that fluting as used in the following description applies to any kind of both corrugated board and solid board. In the event, the term “board” is used alone, it relates to both corrugated board and solid board, and even when referring to “corrugated board” only, the same description is applicable to solid board as well.

To produce products from corrugated board or solid boards, slots or flutes are provided in the board. Slots relate hereby to a cutting of narrow indentations in a board, whereas fluting effects a local compression of the board. The flute lines, which typically involve a straight line, form a crease where the board is then bent to form for example a box from the flat board.

FIG. 1 shows an exemplary sectional illustration of a commercially available corrugated board 1 with one corrugation or wave. The corrugated board 1 includes an upper liner 3, a corrugated medium 5, and a lower liner 7. The corrugated board 1 is very stable, considering its weight, and is therefore usable in many ways for producing boxes or other packaging. It is also known to provide corrugated boards with two, three or even more corrugations and correspondingly several intermediate liners. Flute lines are typically made by a fluting body and a counter body. There are shortcomings, using this process, especially when the quality of the corrugated board is inferior. In this case, fluting causes an undesired tearing of the upper liner 3 or the lower liner 7 of the corrugated board. In addition, practice has shown that even though fluting using a conventional fluting body results in local compression of the corrugated board. Still, the corrugated board reverts back to its original state after fluting so that the flute line is not formed at all or only inadequately. As a result, the flute line is unable to meet the intended task, i.e. to establish a defined crease along which a blank of corrugated board is supposed to be folded. A similar and undesired effect could also be observed, when fluting solid board. Thus, the dimensions of the blank of corrugated board or the box of board is subject to great tolerances and bending of the folded region of the blank of board is subject to great variations.

For example, when the flute lines should extend in orthogonal relation to the upper edge or lower edge of the blank of corrugated board and bending of various panels of the blank is not realized along the flute line because the flute line is formed inadequately, the blank will not close flush after folding. Rather the upper edge or the lower edge of end panels are disposed offset to one another so that the side edge of the one end panel does not precisely lie on a joint on the other end panel of the blank. As a result, the box of corrugated board is fastened askew. The quality of the box is therefore inferior and thus unacceptable.

It would therefore be desirable and advantageous to provide an improved apparatus and method to obviate prior art shortcomings and to enable a precise and reliable fluting of corrugated board.

### SUMMARY OF THE INVENTION

According to one aspect of the present invention, an apparatus for fluting corrugated board or solid board includes a first sonotrode, and a member placed in opposition to the first sonotrode and selected from the group consisting of an anvil and a second sonotrode.

Tests have shown that a board can be manipulated lastingly and locally with the aid of an ultrasound device so as to realize a permanent and very distinct flute line. As a result of the attainable superior geometry of the flute line, the blank of corrugated board can be bent or folded very precisely, reliably and repeatedly. Dimensional tolerances and angle tolerances of folded products of cardboard can be significantly reduced.

Especially the variation of the values of the so-called gap tailings and fish tailings, which represent a reference for the dimensional precision of the corrugated board boxes and the bending capability or parallelism of the edges of the corrugated board boxes, is significantly improved. As a result, product quality is consistent and waste is kept to a minimum. Also, upsetting pressure of bent board blanks that have been fluted in accordance with the invention are superior to boxes that have been fluted conventionally.

To ensure clarity, it is necessary to establish the definition of several important terms and expressions that will be used throughout this disclosure. The term “sonotrode” relates to the part of an ultrasonic welding device that subjects a workpiece to vibrations, produced by an ultrasonic generator. The counterpart to the sonotrode is the anvil. The workpiece, here corrugated board, is compressed between the anvil and the sonotrode at a comparably slight contact pressure. Instead of the anvil, the counterpart to the sonotrode may also be a further or second sonotrode disposed in opposition to the first sonotrode. In this way, ultrasonic vibration is applied even more intensely. For convenience and sake of simplicity, the following description relates in particular to the presence of an anvil, even though the principles described in the following description with respect to “anvil” are equally applicable to an embodiment with two sonotrodes disposed in opposition to one another.

Provided between ultrasound and generator and sonotrode(s) may be a converter and/or a so-called booster. The construction of the ultrasonic device may be similar or identical to a conventional ultrasonic welding device.

According to another advantageous feature of the present invention, the first sonotrode and/or the anvil can be mounted for rotation about a rotation axis. This ensures the formation of straight flute lines in a rapid and reliable manner. The board can be moved through the apparatus or the apparatus can be moved in relation to the board, when the board is stationary.

According to another advantageous feature of the present invention, the first sonotrode and/or the anvil can be rotatably driven.

According to another advantageous feature of the present invention, the first sonotrode may be stationary and have a straight or curved edge of a shape and dimension in correspondence to the desired flute line. This configuration is especially beneficial when flat bed die-cutting of corrugated board blanks is involved.

According to another advantageous feature of the present invention, a feed device can be provided to advance either the sonotrode, anvil, the second sonotrode and/or the corrugated board. The corrugated board may hereby be guided through a gap between the first sonotrode and the anvil or second sonotrode, while the first sonotrode is stationary. Advantageously, the first sonotrode or the anvil may have a wedge-shaped insertion incline at an entry side of the apparatus.

According to another advantageous feature of the present invention, the first sonotrode and the anvil can be spaced from one another by an adjustable distance. Also, a contact pressure between the first sonotrode and the anvil can be adjustable. As a result, the apparatus can be used to process various corrugated boards, for example with one corrugation, two corrugations, or three corrugations, or a solid board in an optimum manner.

According to another advantageous feature of the present invention, a spray device can be provided to locally moisten the corrugated board in the region of the later flute line. Advantageously, the spray device is configured to moisten the board on the side that faces the first sonotrode. This improves application of the ultrasound into the board. It has also been shown as beneficial in some applications to moisten the sonotrode-distal side of the board because in this way, welding is improved to implement the connection or shaping of the various layers of the corrugated board and because of the presence of tensile forces in this region when later the board blanks are bent or folded over. When moistening the board in this region, the risk of tearing of the board is reduced when being bent.

According to another aspect of the present invention, a method includes the steps of compressing a local zone of a solid board or layers of a corrugated board between a first sonotrode and a member selected from the group consisting of an anvil and a second sonotrode, and subjecting the local zone to ultrasound.

According to another advantageous feature of the present invention, the compressing and subjecting steps can be carried out at a same time. Advantageously, the compressing and subjecting steps can be carried out with same tools.

According to still another aspect of the present invention, a computer program embodied in a non-transitory computer readable medium, wherein the computer program, when loaded into the processing device and executed by the processing device, causes the processing device to perform the steps of compressing a local zone of a solid board or layers of a corrugated board between a first sonotrode and a member selected from the group consisting of an anvil and a second sonotrode; and subjecting the local zone to ultrasound.

According to still another aspect of the present invention, a control device for an apparatus for fluting corrugated board is constructed to execute perform the steps of compressing a local zone of a solid board or layers of a corrugated board between a first sonotrode and a member selected from the group consisting of an anvil and a second sonotrode; and subjecting the local zone to ultrasound.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a schematic cross section of a corrugated board with one corrugation;

FIG. 2 is an exemplary schematic plan view of a flat blank of corrugated board;

FIG. 3 is a greatly simplified schematic illustration of a first embodiment of an apparatus according to the present invention for fluting corrugated board or solid board in one mode of application;

FIG. 4 is a section through a corrugated board made by the apparatus according to the present invention;

FIG. 5 is a simplified schematic illustration of a modification of the apparatus according to the present invention for use in another mode of application;

FIG. 6 is a section through a corrugated board with a resultant flute line made by the apparatus of FIG. 5;

FIG. 7 is a simplified perspective illustration of a second embodiment of an apparatus according to the present invention for fluting corrugated board or solid board;

FIG. 8 is a side view of the apparatus of FIG. 7;

FIG. 9 shoes profiles of various sonotrodes and anvils for use in an apparatus according to the present invention for fluting corrugated board or solid board; and

FIG. 10 is a schematic illustration of a third embodiment of an apparatus according to the present invention for fluting corrugated board or solid board.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

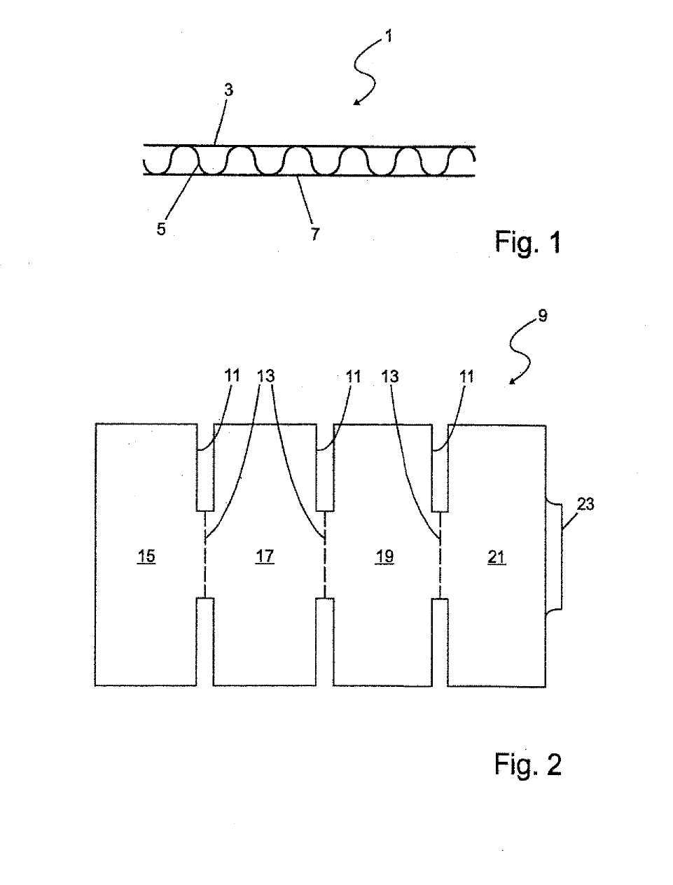

Turning now to the drawing, and in particular to FIG. 2, there is shown a schematic plan view of a flat sheet or blank 9 from which a box or the like can be folded later on, and which has several slots 11 and flute lines 13. The blank 9 is cut in the area of the slots 11, while being only locally compressed in the area of the flute lines 13 to facilitate bending or folding of the corrugated board.

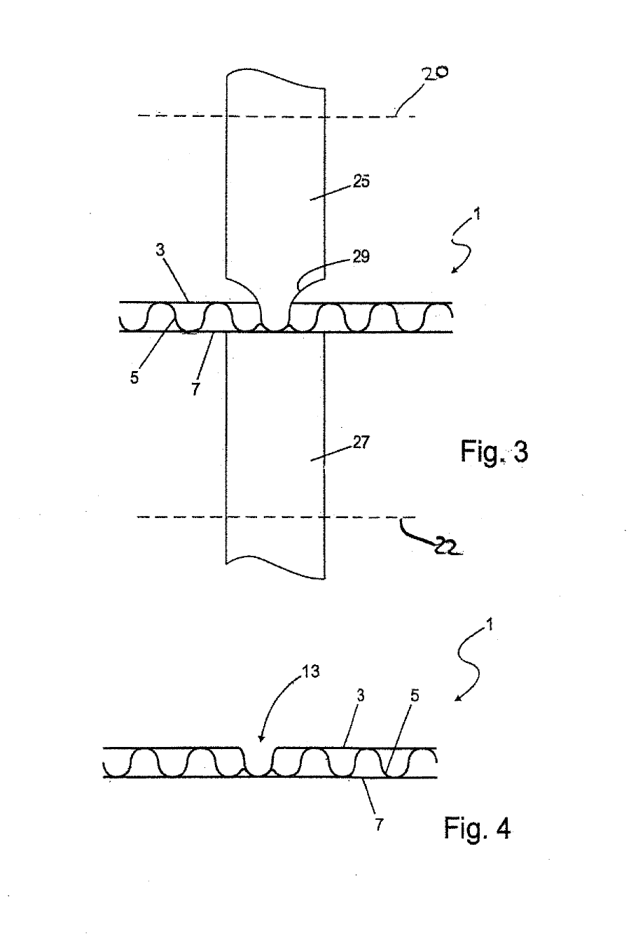

FIG. 3 is a greatly simplified schematic illustration of a first embodiment of an apparatus according to the present invention for fluting a corrugated board, generally designated by reference numeral 1. The apparatus includes a sonotrode 25 which is mounted for rotation about a rotation axis 20, and an anvil 27 which is arranged in opposition to the sonotrode 25 and mounted for rotation about a rotation axis 22. The rotatably mounted sonotrode 25 has a circumferential flute 29 of a shape that resembles a conventional fluting tool. Although not shown in the drawings, the anvil 27 may be replaced instead by a second sonotrode. The corrugated board 1, having by way of example outer liners 3, 7 and an intermediate corrugated medium 5, is advanced between the flute 29 and the anvil 27 (or second sonotrode) and compressed as a result. At the same time, the sonotrode 26 subjects the corrugated board 1 to ultrasound, resulting in the surprising effect that the three layers 3, 5, 7 are connected to one another and a very deep and lasting flute line 13 is established in the corrugated board 1.

FIG. 4 shows the outcome of fluting of the corrugated board 1 with the distinctly noticeable flute line 13 by using ultrasound.

In the exemplified illustrations of FIGS. 3 and 4, the flute 29 of the sonotrode 25 impacts a corrugation at its crest or highest point and presses into the wave shape of the corrugated board 1 to such an extent that the upper liner 3, the involved wave of the corrugated medium 5, and the lower liner 7 directly contact one another and are joined together by the excitation with ultrasound. Practical tests have shown that any commercially available corrugated board can be fluted or provided with a flute line 13 in accordance with the invention in a simple, reliable and lasting manner. Especially advantageous is hereby the substantial depth of the flute line 13 absent any damage to the individual layers 3, 5, 7 of the corrugated board 1.

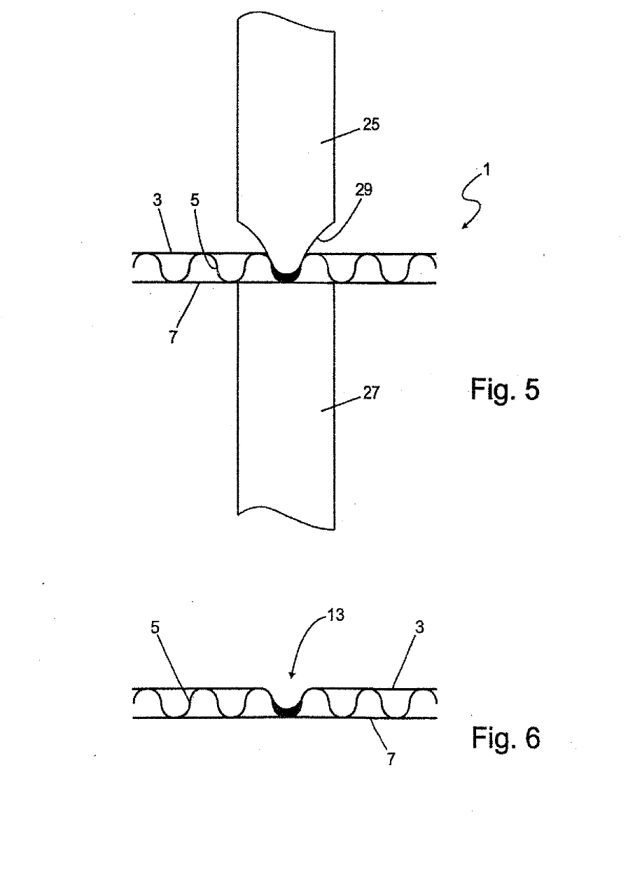

FIG. 5 is a simplified schematic illustration of a modification of the apparatus according to the present invention for use in another mode of application in which the flute 29 impacts essentially a valley of the wave shape of the corrugated medium 5. Also in this case, the layers 3, 5, 7 of the corrugated board 1 are deformed locally and lastingly in the area of the later flute line or crease 13.

In the non-limiting example of FIG. 5, the sonotrode 25 and the anvil 27 are not rotationally symmetrical but configured as elongate structures. The flute 29 of the sonotrode 25 has precisely the geometry of the desired flute line 13 and is pressed from above onto the corrugated board 1. As a result, the flute line 13 is formed over the entire length at the same time. No advance and feed device is required.

FIG. 6 shows the outcome of fluting of the corrugated board 1 with the distinctly noticeable flute line 13 by using ultrasound.

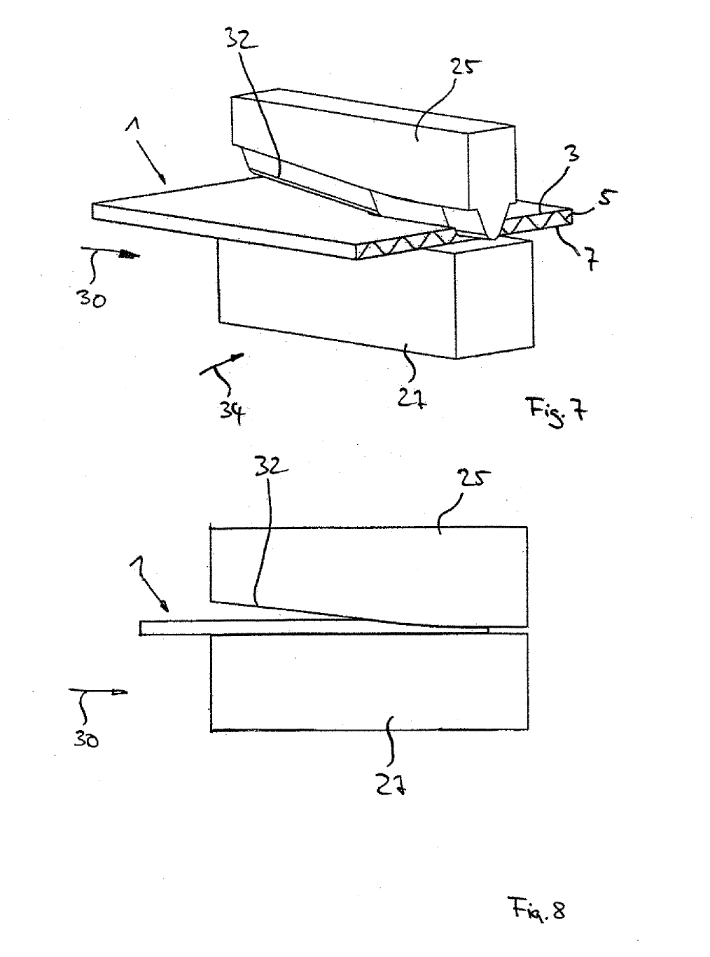

FIG. 7 is a simplified perspective illustration of a second embodiment of an apparatus according to the present invention for fluting a corrugated board 1. Parts corresponding with those in FIG. 5 are denoted by identical reference numerals and not explained again. In this embodiment, the sonotrode 25 and the anvil 27 are, like in FIGS. 5 and 6, not rotationally symmetrical but configured as elongate structures. In contrast to the exemplary embodiment of FIGS. 5 and 6, the flute line 13 is not generated over the entire length at the same time. Rather, the flute line 13 is established as a result of an advance of the corrugated board 1 in relation to the sonotrode 25 and the anvil 27 or by an advance of the sonotrode 25 and the anvil 27 in relation to the corrugated board 1. As the sonotrode 25 is not shaped rotationally symmetrical, it is provided in opposition to the advance direction, indicated by arrow 30, with a wedge-shaped insertion incline 32 of the flute 29 to facilitate insertion of the corrugated board 1.

FIG. 8 is a side view of the apparatus of FIG. 7, viewed in the direction of arrow 34 in FIG. 7. The wedge-shaped insertion incline 32 of the flute 29 is clearly shown here, with the corrugated board 1 having entered at least in part the gap between the sonotrode 25 and the anvil 27.

When considering the exemplary embodiments of FIGS. 3 to 8, it becomes clear that the ultrasonic application to weld or join or shape the layers 3, 5, 7 is independent as to whether the later flute line 13 is at a location where a wave of the corrugated medium 5 has reached its maximum or is formed between two such maxima, i.e. in the area of a wave valley. Of course, it is also possible to form a flute line or crease 13 at an angle that is different than 0°, i.e. slanted or perpendicular to the longitudinal direction of a wave of the corrugated medium 5. In any case, a method according to the invention results in the realization of a very precise and lasting flute line 13.

Precision and process reliability of the apparatus according to the invention or the flute line 13 produced by a method according to the invention is much improved compared to conventional mechanical flutes in corrugated board or solid board and thus enables a precise manufacture of products from board with slight dimensional and angle deviations.

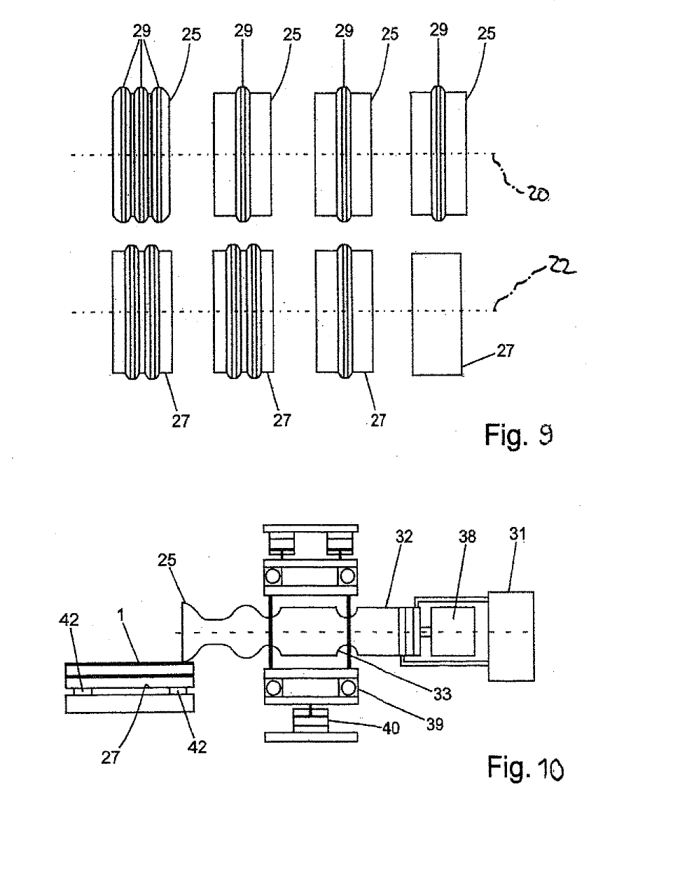

FIG. 9 shows profiles of various sonotrodes 25 and associated anvils 27 for use in an apparatus according to the present invention for fluting a corrugated board or solid board. Sonotrodes 25 and anvils 27 differ in their shape of the flutes. In FIG. 9, the profiles of the sonotrode 25 and anvil 27 on the far right corresponds to the exemplary embodiment of the apparatus according to FIGS. 3 and 5.

FIG. 10 shows a schematic illustration of a third embodiment of an apparatus according to the present invention for fluting a corrugated board 1. The apparatus has an ultrasonic generator 31 which supplies via a converter 32 a booster 33 and ultimately the sonotrode 25 with ultrasound. The converter 32, the booster 33, and the sonotrode 25 are rotatably supported and caused to rotate by an electric motor 38. Reference numeral 39 designates only schematically a bearing assembly for support of the converter 32, the booster 33, and the sonotrode 25. Pneumatic actuators 40 are provided to move the sonotrode 25 in the direction to and from the anvil 27. Force gauges 42, arranged below the anvil 27, ascertain a contact pressure of the sonotrode 25.

In this exemplary embodiment, the sonotrode 25 and the anvil 27 are rotatably mounted. The flute line 13 is established by the interaction of sonotrode 25 and anvil 27. The invention may also be realized when the sonotrode 25 and the anvil 27 are not rotatably supported by stationary.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. Apparatus for fluting corrugated board or solid board, comprising:
a first sonotrode; and
a member placed in opposition to the first sonotrode and selected from the group consisting of an anvil and a second sonotrode.

2. The apparatus of claim 1, wherein at least one of the first sonotrode and the member is mounted for rotation about a rotation axis.

3. The apparatus of claim 1, further comprising an electric motor configured to rotatably drive at least one of the first sonotrode and the member.

4. The apparatus of claim 1, wherein at least one of the first sonotrode and the member is stationary.

5. The apparatus of claim 1, wherein at least one of the first sonotrode and the member is sized to correspond to a flute line to be produced.

6. The apparatus of claim 1, further comprising a feed device constructed to advance a corrugated board or solid board.

7. The apparatus of claim 1, wherein the first sonotrode has a wedge-shaped insertion incline at an entry side of the apparatus.

8. The apparatus of claim 1, further comprising an actuator configured to adjust a distance and/or a contact pressure between the first sonotrode and the member.

9. The apparatus of claim 1, further comprising a spray device constructed to locally moisten the corrugated board.

10. A method, comprising the steps of:
compressing a local zone of a solid board or layers of a corrugated board between a first sonotrode and a member selected from the group consisting of an anvil and a second sonotrode; and
subjecting the local zone to ultrasound.

11. The method of claim 10, wherein the compressing and subjecting steps are carried out at a same time.

12. The method of claim 10, wherein the compressing and subjecting steps are carried out with same tools.

13. The method of claim 10, further comprising the step of moistening a local zone of the solid board or corrugated board prior to and during the compressing step.

14. The method of claim 13, wherein the moistening step involves moistening the solid board or corrugated board on a side proximal to the first sonotrode.

15. The method of claim 13, wherein the moistening step involves moistening the solid board or corrugated board on a side distal to the first sonotrode.

16. The method of claim 10, further comprising the step of moving the solid board or corrugated board in relation to the first sonotrode and the member during or after the subjecting step.

17. The method of claim 10, for execution in a solid board or corrugated board with one corrugation, two corrugations, or more than two corrugations.

18. A computer program embodied in a non-transitory computer readable medium, wherein the computer program, when loaded into the processing device and executed by the processing device, causes the processing device to perform the steps of:
compressing a local zone of a solid board or layers of a corrugated board between a first sonotrode and a member selected from the group consisting of an anvil and a second sonotrode; and
subjecting the local zone to ultrasound.

19. A control device for an apparatus for fluting corrugated board, said control device being constructed to execute perform the steps of:
compressing a local zone of a solid board or layers of a corrugated board between a first sonotrode and a member selected from the group consisting of an anvil and a second sonotrode; and
subjecting the local zone to ultrasound.
